(19) United States
(12) Patent Application Publication
(10) Pub. No.: US 2025/0156279 A1
(43) Pub. Date: May 15, 2025

(54) Method For Managing Project File Of Robot, Robot Management Device, And Robot System

(71) Applicant: SEIKO EPSON CORPORATION, Tokyo (JP)

(72) Inventor: Eiichi OHARA, Matsumoto (JP)

(21) Appl. No.: 18/944,123

(22) Filed: Nov. 12, 2024

(30) Foreign Application Priority Data
Nov. 13, 2023 (JP) 2023-192853

(51) Int. Cl. G06F 11/14

(52) U.S. Cl. CPC G06F 11/1451; G06F 2201/84

(57) ABSTRACT

A method includes (a) a step for acquiring a specific first backup file of a project file and a second backup file that was backed up before the first backup file, (b) a step for creating difference information by detecting a difference from the second backup file to the first backup file, (c) a step for classifying one or more difference items included in the difference information into a plurality of categories, (d) a step for extracting, amongst the difference items, a specific difference item that belongs to a specific category of the plurality of categories, and (e) a step for notifying the specific category of the specific difference item.

The present application is based on, and claims priority from JP Application Serial Number 2023-192853, filed Nov. 13, 2023, the disclosure of which is hereby incorporated by reference herein in its entirety.

### BACKGROUND

### 1. Technical Field

The present disclosure relates to a method for managing a project file of a robot, a robot management device, and a robot system.

### 2. Related Art

JP-A-2013-257790 discloses a technique for acquiring a backup file of a system including a plurality of programmable display devices.

In a robot system, a technique for saving a robot control program and various setting values in a file format of a “project” or a “project file” is used. The project file is a set of information that determines operations of the robot. Therefore, if an unintended change occurs, the quality and cycle time of the work performed by the robot may change, causing quality defects and reduced production efficiency.

However, in the related art, a technique for checking the contents of a backup file of a project file has not been sufficiently devised.

### SUMMARY

According to a first aspect of the present disclosure, a method for managing a project file of a robot is provided. This method includes (a) a step for acquiring a specific first backup file of the project file and a second backup file that was backed up before the first backup file; (b) a step for creating difference information by detecting a difference from the second backup file to the first backup file; (c) a step for classifying one or more difference items included in the difference information into a plurality of categories; (d) a step for extracting, among the difference items, a specific difference item that belongs in a specific category of the plurality of categories; and (e) a step for notifying about the specific category of the specific difference item.

According to a second aspect of the present disclosure, a robot management device for managing a project file of a robot is provided. This robot management device includes a storage section that stores a backup file of the project file; and a difference processing section configured to perform difference processing using the backup file. The robot management device includes a storage section that stores a backup file of the project file, and a difference processing section configured to perform difference processing using the backup file. the difference processing includes (a) a process of acquiring a specific first backup file and a second backup file that was backed up before the first backup file, (b) a process of creating difference information by detecting a difference from the second backup file to the first backup file, (c) a process of classifying one or more difference items included in the difference information into a plurality of categories, (d) a process of extracting, among the difference items, a specific difference item that belongs in a specific category of the plurality of categories, and (e) a process of notifying about the specific category of the specific difference item.

According to a third aspect of the present disclosure, a robot system is provided. This robot system includes one or more robots and a robot management device that manages a project file of the robot. The robot management device includes a storage section that stores a backup file of the project file, and a difference processing section configured to perform difference processing using the backup file. the difference processing includes (a) a process of acquiring a specific first backup file and a second backup file that was backed up before the first backup file, (b) a process of creating difference information by detecting a difference from the second backup file to the first backup file, (c) a process of classifying one or more difference items included in the difference information into a plurality of categories, (d) a process of extracting, among the difference items, a specific difference item that belongs in a specific category of the plurality of categories, and (e) a process of notifying about the specific category of the specific difference item.

### BRIEF DESCRIPTION OF THE DRAWINGS

FIG. 1 is an explanatory diagram showing a configuration of a robot system.

FIG. 2 is a functional block diagram of a robot controller and a robot management device.

FIG. 3 is an explanatory diagram showing an example of difference categories.

FIG. 4 is an explanatory diagram showing an example of whether an action is “necessary or unnecessary” that is set for each category.

FIG. 5 is a flowchart showing an overall procedure of difference processing.

FIG. 6 is a flowchart showing a detailed procedure of the difference information creation process.

FIG. 7 is an explanatory diagram showing an example of a backup history.

FIG. 8 is an explanatory diagram showing an example of difference information.

FIG. 9 is an explanatory diagram showing an example of a screen for setting a mail address of a contact point.

FIG. 10 is a flowchart showing a process procedure of a display process of a backup history list.

FIG. 11 is an explanatory diagram showing an example of a display screen of the backup history list.

FIG. 12A is an explanatory diagram showing an example of a monitoring screen of the robot controller.

FIG. 12B is an explanatory diagram showing an example of the monitoring screen of the robot controller.

FIG. 13 is an explanatory diagram showing another example of a monitoring screen of the robot system.

FIG. 14A is an explanatory diagram showing still another example of the monitoring screen of the robot system.

FIG. 14B is an explanatory diagram showing the still another example of the monitoring screen of the robot system.

FIG. 15 is an explanatory diagram showing an example of the monitoring screen of consumable goods of the robot.

FIG. 16 is an explanatory diagram showing an example of a monitoring screen of working states of the robot.

### DESCRIPTION OF EMBODIMENTS

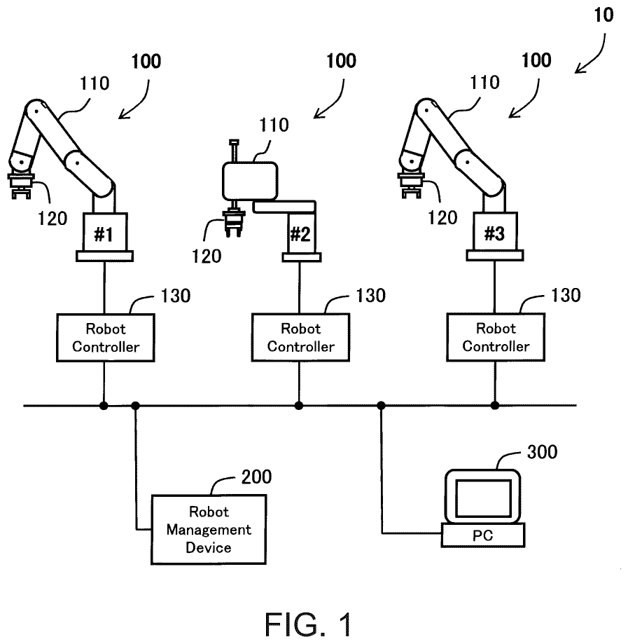

FIG. 1 is an explanatory diagram showing an example of a robot system 10 in one embodiment. The robot system 10 includes one or more robots 100, a robot management device 200 that manages the robots 100, and one or more terminal devices 300. In this example, the robot system 10 includes three robots 100. These robots 100 will be referred to as “robot #1”, “robot #2”, and “robot #3” for convenience.

Each robot 100 includes a robot main body 110, a peripheral device 120, and a robot controller 130 that controls the robot main body 110 and the peripheral device 120. The robot management device 200 is realized by a computer having a microprocessor and a memory. The robot management device 200 is connected to the robots 100 and the terminal device 300 via a wired or wireless communication line. In other words, the robot system 10 is configured as a network including one or more robots 100. In a typical example, the entire robot system 10 is provided in one factory. The robot controller 130 may control a plurality of robot main bodies 110.

The terminal device 300 is a personal computer or a smartphone. The terminal device 300 is used as a display terminal that displays various screens provided from the robot management device 200. The terminal device 300 is also used as a receiving terminal that receives a mail regarding difference information of a backup file from the robot management device 200. Note that the robot management device 200 may be configured as a server provided in an external network or a cloud server.

The robot main body 110 can be configured with a manipulator having any robot arm mechanism with a plurality of joints. In the example of FIG. 1, robot #1 and robot #3 are vertically articulated robots, and robot #2 is a horizontal articulated robot.

The peripheral device 120 may include one or more of a variety of devices used in the work of the robot 100, such as end effectors, force sensors, cameras, parts feeders, transport conveyor devices, and the like.

A project file of each robot 100 is stored in the robot controller 130 of each robot 100. A backup file of the project file is created by each of the robot controllers 130. A robot management device 200 is configured to execute difference processing that acquires a plurality of backup files of the project file and that analyzes differences between them.

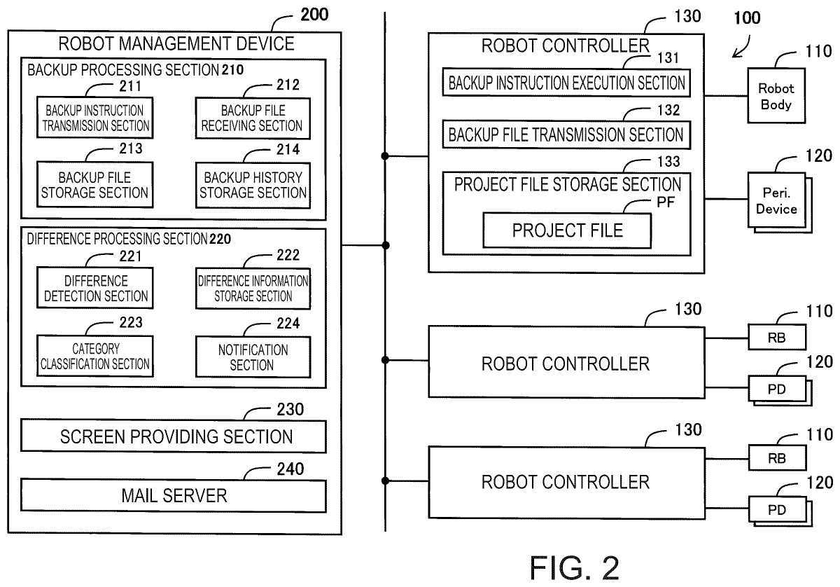

FIG. 2 is a functional block diagram of the robot controller 130 and the robot management device 200. The robot controller 130 has a backup instruction execution section 131, a backup file transmission section 132, and a project file storage section 133. The project file storage section 133 stores a project file PF. The project file PF is the latest project file used in that robot 100.

The project file PF is a set of information that determines an operation of the robot 100 including the robot main body 110 and the peripheral device 120. For example, the project file PF includes at least a portion of the following various data a1 to a8.
(a1) Model information such as a type and a name of the robot
(a2) Mechanical structure information such as information on a length and an offset of joints of the robot
(a3) Robot control program
(a4) Teaching point information
(a5) Calibration information of the robot
(a6) Setting values of peripheral devices such as a camera, a force sensor, and a parts feeder
(a7) Setting values of a communication system
(a8) Log data of robot work
   The log data of robot work includes a state, an error, a warning, and an operation log of the robot main body 110 and the robot controller 130, and also includes log data of the peripheral device 120.

Which of the above-mentioned data a1 to a8 is to be included in the project file PF is determined in advance according to the control method of each robot 100.

In the project file PF, the same type of data may be divided into two or more data files. For example, the teaching point information may consist of each teaching point as a single data file. The robot control program may also consist of a plurality of program files. The same applies to other data.

The backup instruction execution section 131 executes a backup instruction to create a backup file of the project file PF, which is stored in the project file storage section 133. In the present embodiment, the backup instruction is sent from the robot management device 200 to the robot controller 130, and the robot controller 130 executes the backup process in response to this instruction. The robot controller 130 may execute the backup process of the project file PF at regular intervals or when a specific event occurs. The backup file transmission section 132 sends the created backup file to the robot management device 200. Here, the robot management device 200 may be configured to acquire the project file PF and to create the backup file in the robot management device 200.

Each backup file may be configured to include the entire changed project file PF as it is. Alternatively, each backup file may be configured not to include data that does not differ from a backup file created immediately before it, but to include data that differs from the backup file created immediately before it. In other words, the backup file may be configured with only differences. In the latter case, capacity of the backup file can be reduced.

If a robot control program is included in the project file PF, the robot controller 130 has a function of controlling the robot main body 110 according to that robot control program. However, this control function is not shown in FIG. 2. Various functions of the robot controller 130 are realized by a processor executing a computer program stored in a memory. However, some or all of the functions of the robot controller 130 may be realized by a hardware circuit.

The robot management device 200 has a backup processing section 210, a difference processing section 220, a screen providing section 230, and a mail server 240. Various functions of the robot management device 200 are realized by a processor executing a computer program stored in the memory. However, some or all of the functions of the robot management device 200 may be realized by hardware circuitry.

The backup processing section 210 has a backup instruction transmission section 211, a backup file receiving section 212, a backup file storage section 213, and a backup history storage section 214.

The backup instruction transmission section 211 transmits a backup instruction of the project file PF to the robot controller 130. The backup file receiving section 212 receives a backup file from the robot controller 130. The backup file storage section 213 stores the received backup file. The backup file storage section 213 stores a plurality of backup files that have been backed up in the past. The backup history storage section 214 stores a history of the backup process of the project file PF. The backup history will be described later.

The difference processing section 220 has a difference detection section 221, a difference information storage section 222, a category classification section 223, and a notification section 224.

The difference detection section 221 selects two backup files for the difference processing from among a plurality of backup files stored in the backup file storage section 213, then executes the difference information creation process, by detecting the differences between them, to create difference information. Two backup files for the difference information creation process are referred to as a “first backup file” and a “second backup file”. The second backup file is a backup file that was backed up before the first backup file, and both are backup files related to the same specific robot 100. Among a plurality of backup files stored in the backup file storage section 213, the latest backup file regarding a specific robot 100 is desirably selected as the first backup file. The second backup file is desirably selected to be a backup file related to the same robot 100 as is the first backup file and also the backup file that was backed up at timing closest to the timing when the first backup file was backed up.

When the latest backup file is used as the first backup file, the difference information creation process may be executed using the backup process of the first backup file as a trigger. Specifically, the difference information creation process may be started using, as a trigger, an event in which a new backup file is stored in the backup file storage section 213. In this way, it is possible to quickly know that a change has occurred in the project file.

The difference information storage section 222 stores difference information created by the difference detection section 221. The category classification section 223 classifies one or more difference items included in the difference information into a plurality of categories. Examples of the plurality of categories will be described later. The notification section 224 executes a process of notifying the user of a category of the difference item. The “notification” may be executed, for example, as a display on the terminal device 300, or as to inform preset contact point, that is, as to send a mail using the mail server 240.

The screen providing section 230 functions as a Web server that creates various screens related to the robot system 10 and provides them to the terminal device 300. Examples of various screens provided by the screen providing section 230 will be described later.

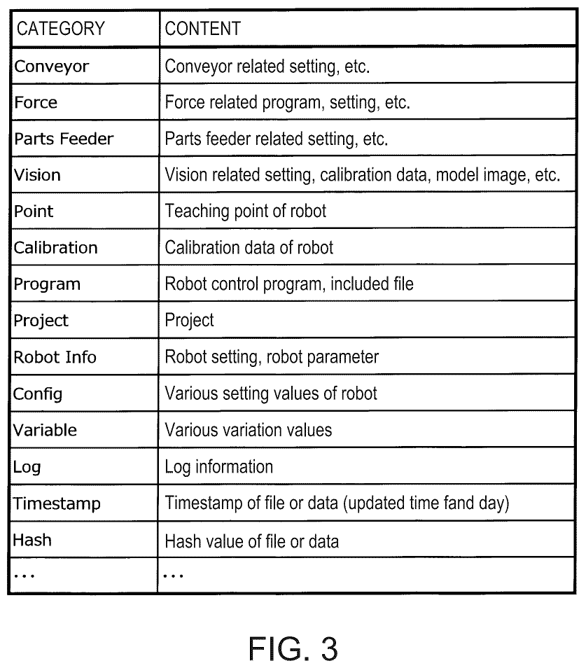

FIG. 3 is an explanatory diagram showing an example of difference categories. The difference categories include the following data type categories: Cat1 to Cat12 and file attribute categories: Cat13 and Cat14.

### Data Type Categories

(Cat1) Conveyor: transport conveyor related
(Cat2) Force: force sensor related
(Cat3) Parts feeder: parts feeder related
(Cat4) Vision: vision sensor related, such as a camera
(Cat5) Point: teaching point
(Cat6) Calibration: robot calibration
(Cat7) Program: robot control program
(Cat8) Project: project
(Cat9) Robot Info: robot setting, robot parameters
(Cat10) Config: various set values of robot
(Cat11) Variable: various variable values
(Cat12) Log: log information.

### File Attribute Categories

(Cat13) Timestamp: update date and time of the project file or data file
(Cat14) Hash: hash value of project file or data file

The data type category is a category that indicates a type of data in which the difference occurred. The file attribute category is a category relating to an attribute of the entire project file.

In addition to the data type category described above, data change types may also be used. Three types of the data change type can be used, for example, “add”, “delete”, and “change”. One data type category and one data change type may be assigned together for one difference.

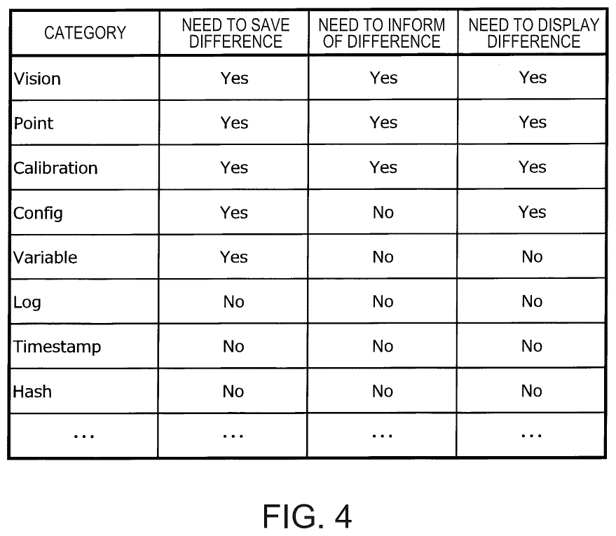

FIG. 4 is an explanatory diagram showing an example of whether an action is “necessary or unnecessary” that was set for each category. As necessity of actions, three kinds of the necessity of actions are set: (1) need to save differences; (2) need to inform of differences; and (3) need to display differences.

A category in which “need to save differences” is “Yes” means that differences belonging to this category need to be stored. For example, a difference that should be saved from a viewpoint of a change point management of the project file PF should be set as “need to save”. The change point management is management related to when and how the project file PF has been changed.

A category in which “need to inform of differences” is “Yes” means that differences belonging to this category need to be informed to the user by mail. For example, it is desirable to set “need to inform” for differences that the user of the robot system 10 needs to know.

A category in which “need to display” is “Yes” means that differences belonging to the category needs to be displayed on the terminal device 300. For example, it is desirable to set “need to display” for differences that need to be made observable to the user of the robot system 10.

If an excessive number of categories are set to “need to inform”, the user will receive notices frequently, which may be bothersome. Therefore, it is desirable to limit categories that will be set to “need to inform” to a portion of categories that were set to “need to display”.

“Inform” and “display” are examples of “notification” in the present disclosure. Instead of separately setting “need to inform” and “need to display” as in the example of FIG. 4, “need to notify” may be set. As described above, in the present embodiment, the need for actions such as “save differences” and “notification” is set in advance for one or more specific categories among a plurality of categories. The specific category for which the action is necessary is desirably selected from among the data type categories.

The specific category that needs the action can be arbitrarily set by the user. For example, the following categories may be selected as the specific category.
(1) A category including information for determining an operation of a robot system.
   This category is, for example, a category relating to data a2 to a7 described above.
(2) A category including information that will be changed by a user operation among the information for determining the operation of the robot system.
   This category is, for example, a category relating to data a3 to a7 described above.
(3) A category that includes information that will be changed by a user operation.
   This category is, for example, the category relating to data a1 to a8 described above.

Differences in categories for which all of above described actions are unnecessary may be deleted without leaving them in the difference information. Note that it is desirable that the necessity of actions will be set for each of the data type categories described above.

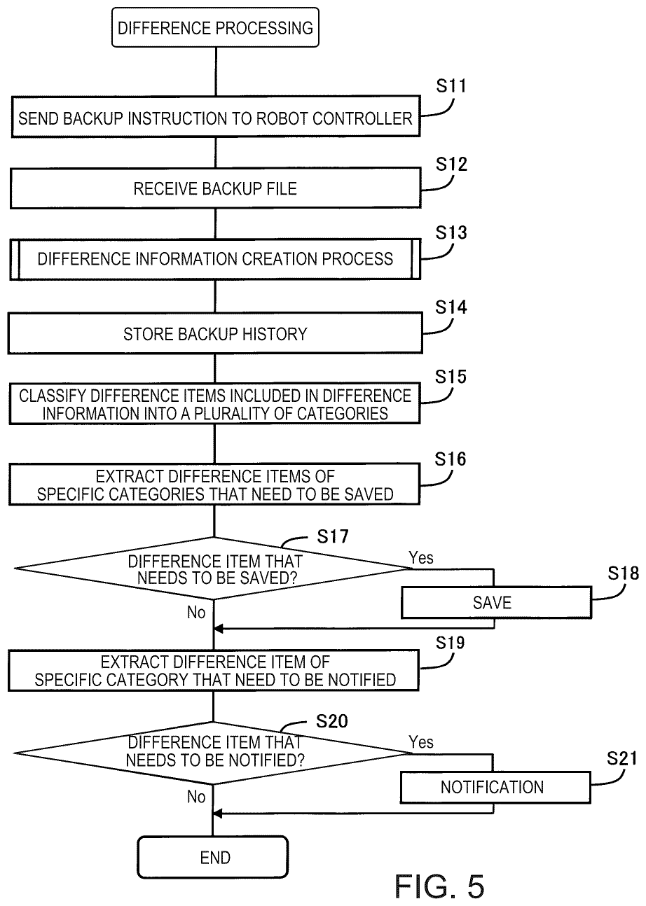

FIG. 5 is a flowchart showing an overall procedure of difference processing. In step S11, the backup instruction transmission section 211 sends a backup instruction to the robot controller 130. In step S12, the backup file receiving section 212 receives a backup file from the robot controller 130. This backup file is stored in the backup file storage section 213. In step S13, the difference detection section 221 executes a process of creating difference information.

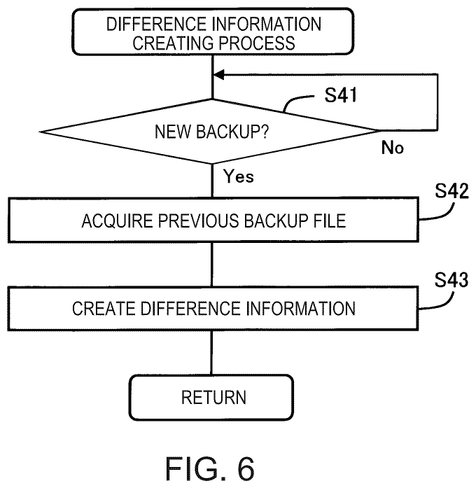

FIG. 6 is a flowchart showing a detailed procedure of the difference information creation process. In step S41, the process waits until a new backup is executed, that is, until a new backup file is received. When a new backup file is received, in step S42, the difference detection section 221 acquires the previous backup file from the backup file storage section 213. The new backup file corresponds to a “first backup file”, and the previous backup file corresponds to a “second backup file”. As described above, the first backup file and the second backup file are project files regarding the same robot.

In step S43, the difference detection section 221 creates difference information by detecting differences from the second backup file to the first backup file. When the process of creating the difference information is completed, the process proceeds to step S14 in FIG. 5.

In step S14, the backup history storage section 214 stores a backup history.

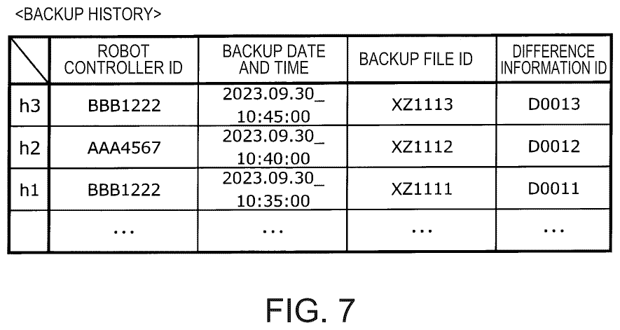

FIG. 7 is an explanatory diagram showing an example of the backup history. In this example, three backup histories h1-h3 are recorded. Each backup history includes (1) a robot controller ID, (2) a backup date and time, (3) a backup file ID, and (4) a difference information ID.

In step S15, the category classification section 223 classifies the difference items included in the difference information into a plurality of categories.

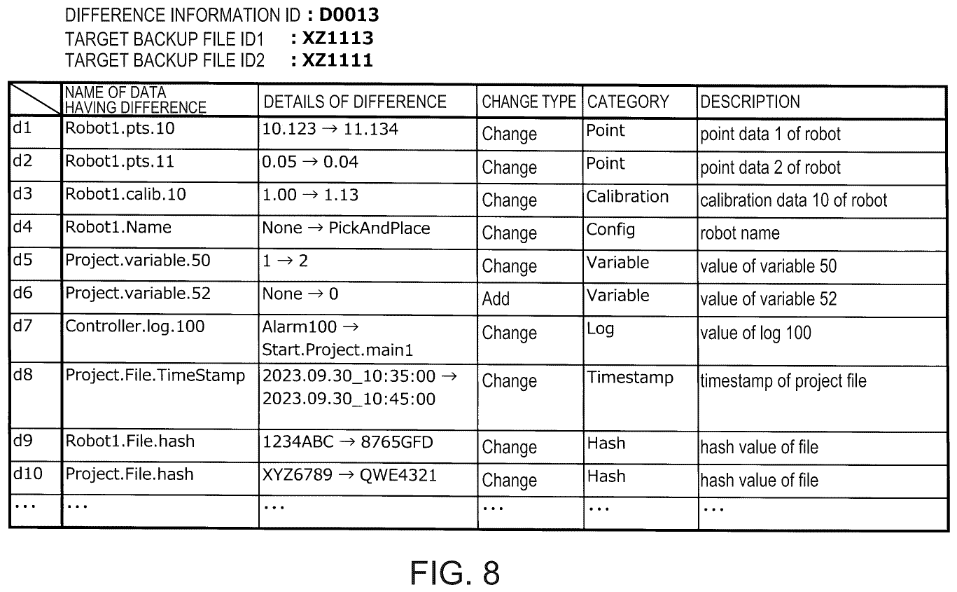

FIG. 8 is an explanatory diagram showing an example of difference information. In this example, difference information D0013, which indicates differences from a backup file XZ1111 to a backup file XZ1113, is created. The difference information D0013 includes a plurality of difference items d1 to d10. Each difference item registers (1) a data name that has a difference, (2) details of the difference, (3) change type, and (4) category. The “description” in the right end column of FIG. 8 is included for convenience. One difference item means one difference. In general, the difference information is created to have one or more difference items.

In step S16 of FIG. 5, the category classification section 223 extracts, from the difference information, difference items that belong in the specific category that needs to be stored. In the example of FIG. 4 described above, the specific categories that need to be saved are five of “Vision”, “Point”, “Calibration”, “Config”, and “Variable”. Therefore, among the plurality of difference items d1 to d10 shown in FIG. 8, the difference items d1 to d6, which belong in any of these five specific categories, are extracted in step S16. In step S17, the category classification section 223 checks whether or not there is a difference item that needs to be saved, and if there is a difference item that needs to be saved, the difference item is saved in the difference information storage section 222 in step S18.

In step S19, the notification section 224 extracts difference items that belong in a specific category that need notification from among the difference items of the difference information. As the “notification”, at least one of “display on the terminal device 300” and “to inform by mail” can be used. For example, when “to inform by mail” is executed as “notification”, difference items that belong in a specific category that need to be informed by mail are extracted in step S19. In the example of FIG. 4 described above, the specific categories that need notification by mail are “Vision”, “Point”, and “Calibration”. Therefore, among the plurality of difference items d1 to d10 shown in FIG. 8, the difference items d1 to d3, which belong in one of these three specific categories, are extracted in step S19. In step S20, the notification section 224 checks whether or not there is a difference item that needs notification. If there is a difference item that needs notification, the notification section 224 executes notification to the user in step S21. It is desirable that contents of this notification include at least identification information for identifying the robot 100 or the robot controller 130 and the specific categories of the difference items extracted in step S19. By this, the user can easily understand what kind of change has been made to the project file for which robot 100.

The contents of the notification may be created so as to include contents of the difference items. It is desirable that these contents of the difference items include a data file name in which the difference items exist. The contents of the difference items may include details of the difference shown in FIG. 8.

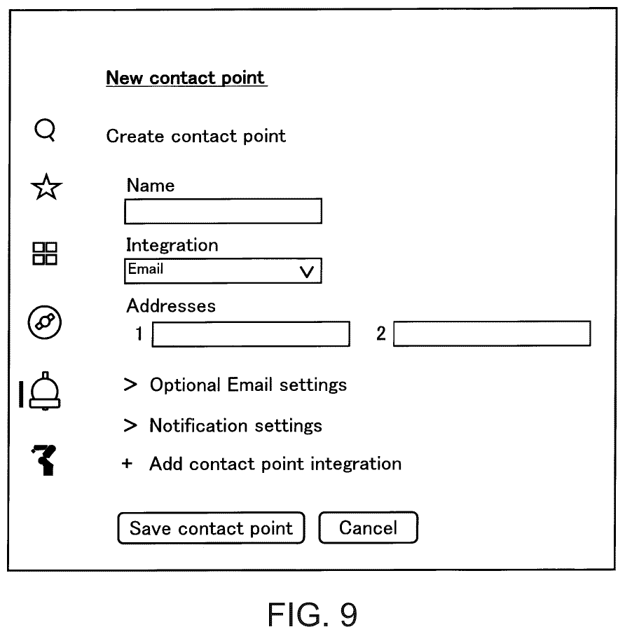

FIG. 9 is an explanatory diagram showing an example of a screen for setting a mail address of a contact point. In this example, it is possible to arbitrarily register one or more mail addresses as a new contact point. Such setting of contact points is desirably executed before start of the difference processing in FIG. 5.

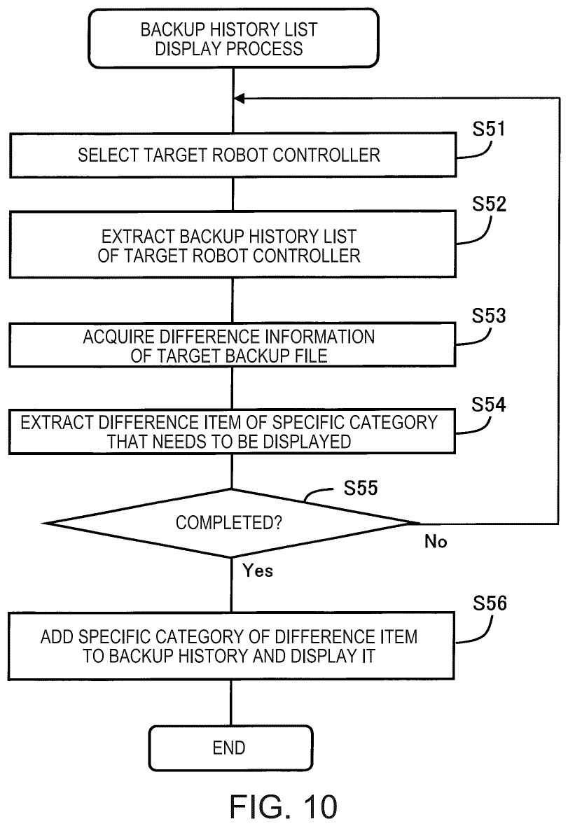

FIG. 10 is a flowchart showing a process procedure of a display process of a backup history list. This process is a process in which the screen providing section 230 creates a screen including the backup history list and supplies the screen to the terminal device 300 to display the screen. In step S51, the user of the terminal device 300 selects a target robot controller to display its backup history. In step S52, the screen providing section 230 extracts a backup history of the target robot controller from the backup histories shown in FIG. 7. The backup history is read out from the backup history storage section 214.

In step S53, the screen providing section 230 acquires difference information of the target backup file. The difference information has the same contents as those shown in FIG. 8 described above. In step S54, the screen providing section 230 extracts difference items of the specific categories that needs to be displayed. In the above-described example of FIG. 4, categories that needs to be displayed are four categories of “Vision”, “Point”, “Calibration”, and “Config.” Therefore, difference items that belong in these specific categories are extracted.

In step S55, it is determined whether or not the processes of steps S51 to S54 have been completed for the controller that should be the target for displaying the backup history, and if not completed, the process returns to step S51 and the process of steps S51 to S54 is executed again. If the processes of steps S51 to S54 have been completed for the controller that should be the target for displaying, the process proceeds to step S56 and the screen providing section 230 creates a screen in which the specific categories of the difference items are added to the backup history, and sends it to the terminal device 300 to display it.

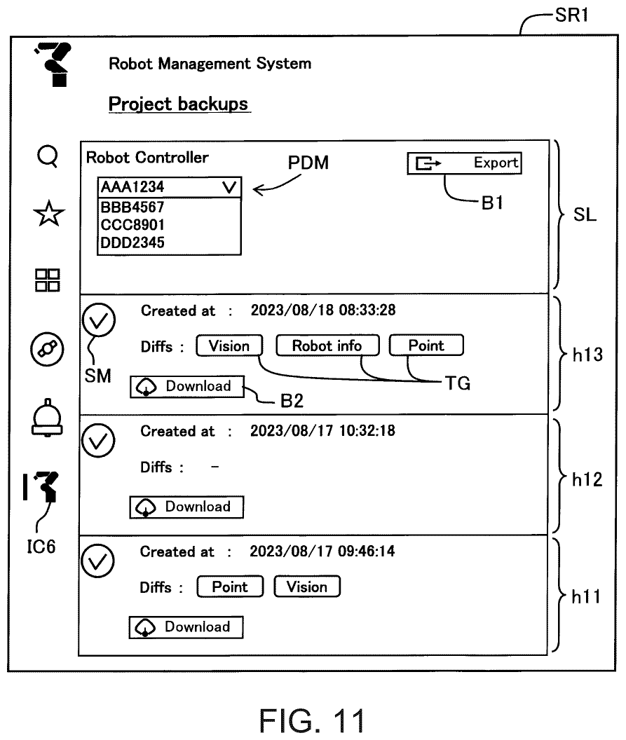

FIG. 11 is an explanatory diagram showing an example of the display screen SR1 of the backup history list in which the specific categories of the difference items are displayed. The display screen SR1 is a kind of monitoring screen of the robot management system, by arbitrarily selecting one of a plurality of icons displayed on the left side of the display screen SR1, it is possible to display various information in order to manage the robot. In the example of FIG. 11, the sixth icon IC6 has been selected, and the screen displays the backup history list of the project file. The backup history list includes a robot controller selection section SL and backup history display sections h11 to h13.

The robot controller selection section SL is provided with a pull-down menu PDM for selecting a robot controller and an export button B1. By pressing the export button B1, the user can download an export file of the backup history from the robot management device 200 to the terminal device 300. This export file includes a list of one or more backup files, each of which includes the specific category of difference items. The export file desirably includes a list of two or more backup files, and more desirably includes a list of all backup histories for that robot controller. The export file may include not only a list of the backup histories but also backup files themselves, or may include difference information in each history. The export file can be used for other processes such as quality control.

Each of the backup history display sections h11 to h13 includes a status mark SM that indicates backup status, backup date and time, a tag TG that indicates a category of the difference item, and a download button B2. The status mark SM indicates one of several statuses in the backup process, such as “planned”, “executing”, “executed (success)”, or “executed (error)”. In the example of FIG. 11, the status mark SM for all three histories all indicate that they are “executed (success)”.

In the backup history display section h13, the tags TG indicating the category of the difference item is displayed. When the user selects a tag TG in one category, details of its difference information may be displayed. This detailed display is configured to include, for example, a data name including the differences and details of the difference. Note that instead of the tag TG, another display element such as an icon may be used to indicate the category. In this way, by displaying the categories of the difference items in the backup history list, the user can easily grasp an outline of the difference information.

The download button B2 is used to download the backup file of the backup history from the robot management device 200 to the terminal device 300.

In other embodiments, the list of backup files may be displayed using one of the following methods.
(1) Display only backup files including difference information in the list.
(2) Display backup files including difference information and the latest backup file in the list.
(3) Display all backup files in the list.
(4) Display only backup files that have difference information of a specified category. For example, when “Vision” is specified, only backup files having difference information of “Vision” are displayed in the list.
(5) Display any two backup files selected by the user in the list.

As described above, in the present embodiment, a notification about the specific category of difference items included in the difference information is performed in step S21 of FIG. 5, so that the user can easily grasp, among large and complex backup files, whether or not there are difference items relating to the specific categories that the user is interested in. The user can also check whether or not an unintentional change was made to a project file from the specific categories of the difference items. As the method of notifying the specific categories of the difference items, a display screen including a table that shows details of the difference information as shown in FIG. 8 may be displayed on the screen, in addition to the display screen SR1 shown in FIG. 11.

The screen providing section 230 can further create various monitoring screens as described below and cause the terminal device 300 to display them.

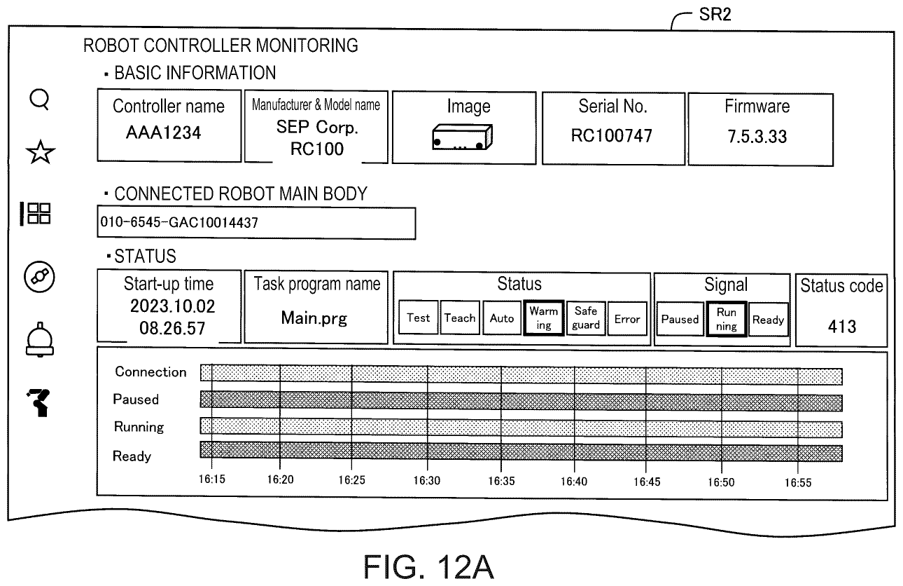

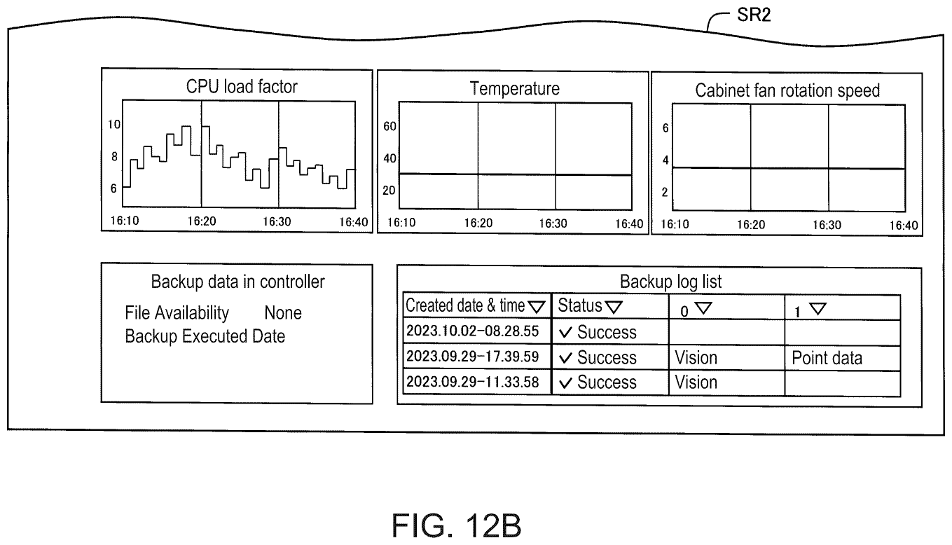

FIGS. 12A and 12B are explanatory diagrams showing an example of a monitoring screen SR2 of the robot controller. On the monitoring screen SR2, it is possible to select a robot controller to be monitored and to display status of the various monitoring items. The monitoring items include information such as start time, task program name, status, signal, CPU load factor, temperature, cabinet fan rotation speed, presence or absence of backup file in the controller, and backup log list.

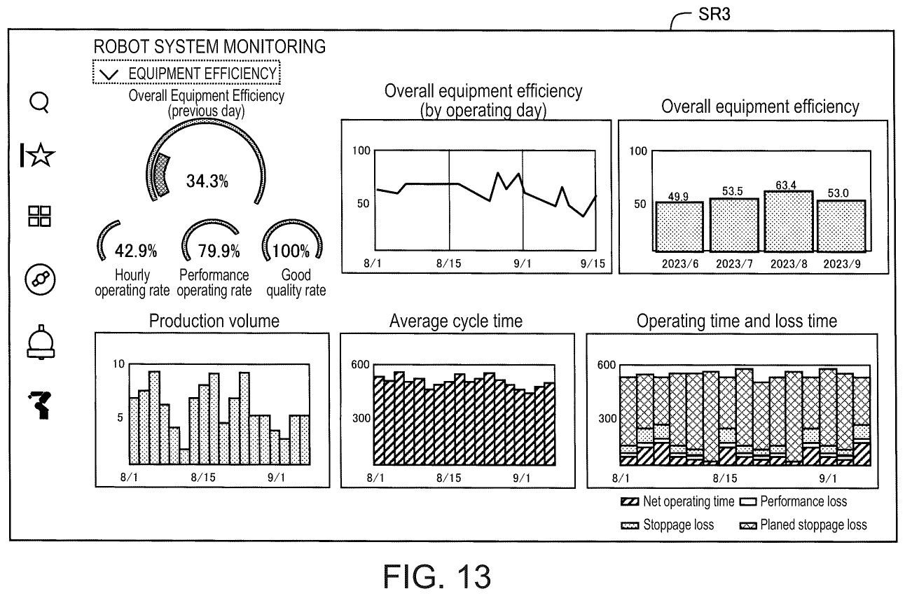

FIG. 13 is an explanatory diagram showing an example of a monitoring screen SR3 of the robot system. On the monitoring screen SR3, information such as equipment efficiency, production volume, cycle time, and the operation time is graphically displayed.

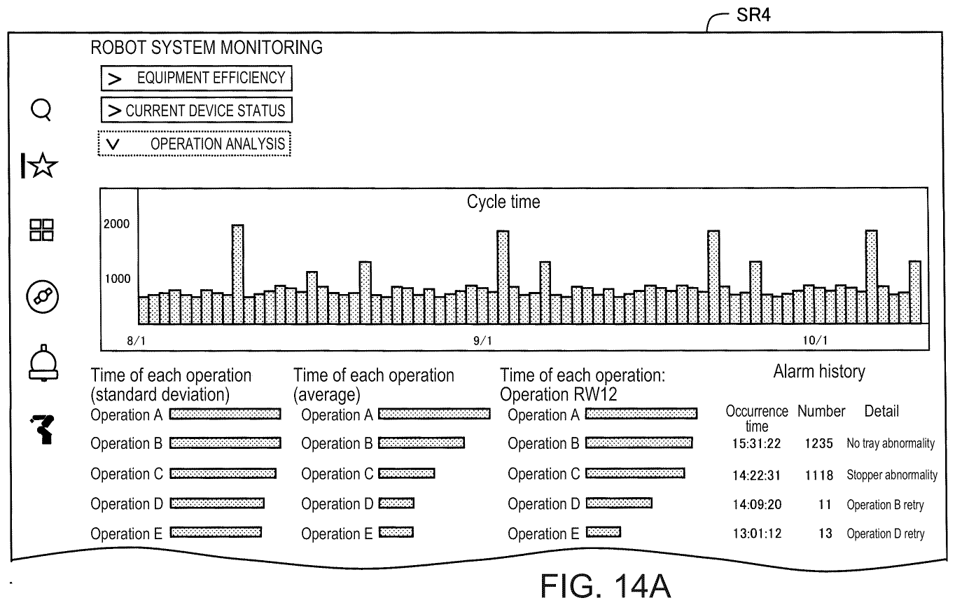

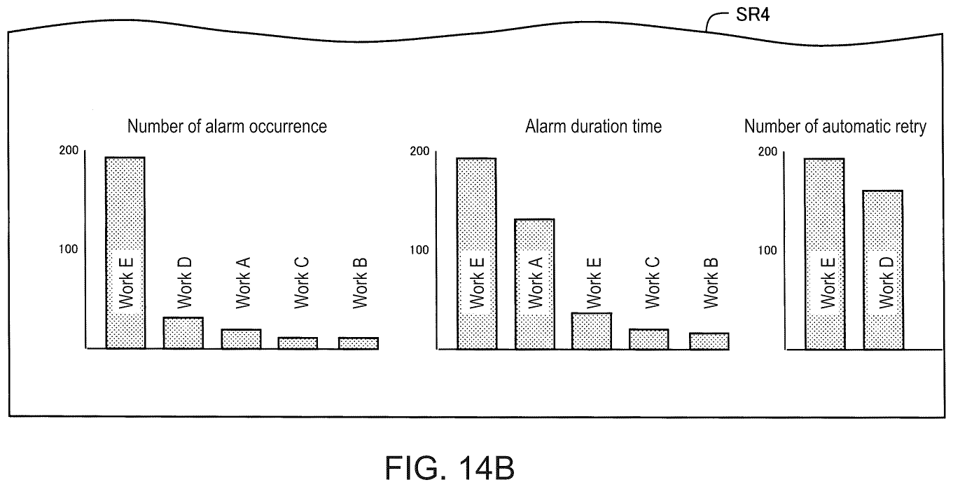

FIGS. 14A and 14B are explanatory diagrams showing another example of a monitoring screen SR4 of the robot system. The monitoring screen SR4 displays a list of information relating to the cycle time of each work, alarms, and the like. In a case where an operation of the robot 100 is extremely slow or is stopped due to an abnormality, the cycle time will be longer, so the occurrence of an abnormality can be estimated from the length of the cycle time.

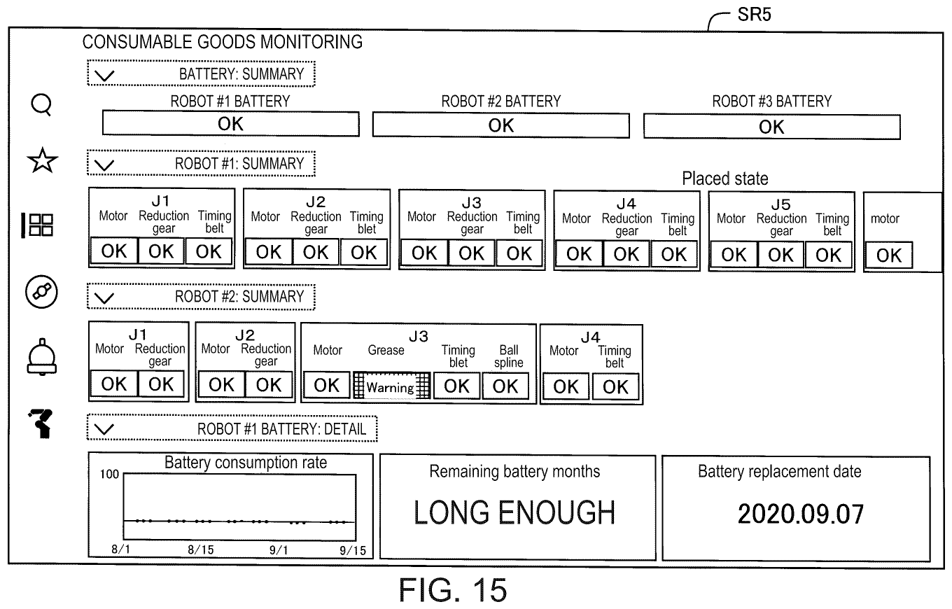

FIG. 15 is an explanatory diagram showing an example of a monitoring screen SR5 of consumable goods of the robot. On the monitoring screen SR5, it is possible to confirm whether or not various consumable goods are nearing the end of their service life.

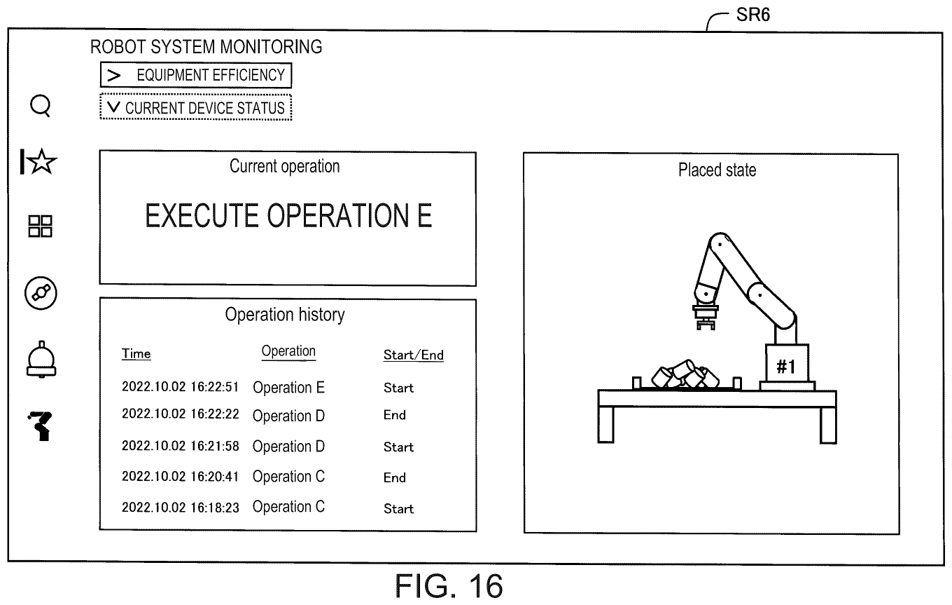

FIG. 16 is an explanatory diagram showing an example of a monitoring screen SR6 of a working state of the robot. In this monitoring screen SR6, it is possible to display a work history and image that was captured the working state by the camera for each robot.

### Other Aspects

The present disclosure is not limited to the embodiments described above, but can be realized in various forms without departing from the scope of the present disclosure. For example, the present disclosure can also be realized by the following aspects. The technical features in the above embodiments that correspond to the technical features in each aspect described below can be replaced or combined as appropriate to solve some or all of the issues of this disclosure or to achieve some or all of the effects of this disclosure. If a technical feature is not described as an essential feature in the present specification, the technical feature can be deleted as appropriate.
(1) According to a first aspect of the present disclosure, a method for managing a project file of a robot is provided. This method includes (a) a step for acquiring a specific first backup file of the project file and a second backup file that was backed up before the first backup file; (b) a step for creating difference information by detecting a difference from the second backup file to the first backup file; (c) a step for classifying one or more difference items included in the difference information into a plurality of categories; (d) a step for extracting, among the difference items, a specific difference item that belongs in a specific category of the plurality of categories; and (e) a step for notifying about the specific category of the specific difference item.
   According to this method, the user can easily grasp whether or not there are difference items relating to the specific category that the user is interested in in a large and complex backup file of the project file. The user can also check whether or not an unintentional change was made to a project file from the specific categories of the difference items.
(2) In the above-described method, the steps (a) through (e) may be executed by triggering a backup process of the first backup file. According to this method, it is possible to quickly grasp that a change has occurred in the project file of the robot.
(3) In the above methods, the step (e) may include a step for notifying a preset contact point of the specific category of the specific difference item. According to this method, it is possible to efficiently confirm that there has been a change in the project file without having to perform any work such as logging in to the management system.
(4) The method may further include a step for creating a backup file history list that includes the second backup file and the first backup file, assigning the specific category of the specific difference item to the backup file history list and displaying it. According to this method, it is possible to easily grasp which category of data has been changed from the backup file history list.
(5) In the above methods, the first backup file may be configured to include data having a difference from the second backup file, without including data having no difference from the second backup file. According to this method, capacity of the backup file can be reduced.
(6) The method may further include a step for exporting a list of one or more backup files, each of which includes the specific category of the specific difference item. According to this method, the backup history including the specific category of the specific difference item can be used for other process such as quality control.
(7) In the above methods, the step (e) may include a step for notifying about content of the specific difference item together with the specific category. According to this method, the difference between the first backup file and the second backup file can be easily grasped.
(8) In the method, the project file may include a plurality of data files and the content of the specific difference item may include a data file name in which the specific difference item exists. According to this method, it is possible to grasp which data file among the plurality of data files included in the project file has a difference.
(9) According to a second aspect of the present disclosure, a robot management device is provided that manages a project file of a robot. This robot management device includes a storage section that stores a backup file of the project file and a difference processing section configured to perform difference processing using the backup file. The robot management device includes a storage section that stores a backup file of the project file, and a difference processing section configured to perform difference processing using the backup file. The difference processing includes (a) a process of acquiring a specific first backup file and a second backup file that was backed up before the first backup file, (b) a process of creating difference information by detecting a difference from the second backup file to the first backup file, (c) a process of classifying one or more difference items included in the difference information into a plurality of categories, (d) a process of extracting, among the difference items, a specific difference item that belongs in a specific category of the plurality of categories, and (e) a process of notifying about the specific category of the specific difference item.
(10) According to a third aspect of the present disclosure, a robot system is provided. This robot system includes one or more robots and a robot management device that manages a project file of the robot. The robot management device includes a storage section that stores a backup file of the project file, and a difference processing section configured to perform difference processing using the backup file. The difference processing includes (a) a process of acquiring a specific first backup file and a second backup file that was backed up before the first backup file, (b) a process of creating difference information by detecting a difference from the second backup file to the first backup file, (c) a process of classifying one or more difference items included in the difference information into a plurality of categories, (d) a process of extracting, among the difference items, a specific difference item that belongs in a specific category of the plurality of categories, and (e) a process of notifying about the specific category of the specific difference item.

The present disclosure can be realized in various forms other than the above. For example, the present disclosure can be realized in forms such as a robot system including a robot and a robot control device, a computer program for realizing functions of the robot control device, and non-transitory recording media in which the computer program is recorded.

The backup file of the robot project of the present disclosure may simply be a copy of the project file. In other words, the difference information may be created by comparing all or a part of the latest project file with the saved past project file.

What is claimed is:

1. A method for managing a project file of a robot, the method comprising:
(a) a step for acquiring a specific first backup file of the project file and a second backup file that was backed up before the first backup file;
(b) a step for creating difference information by detecting a difference from the second backup file to the first backup file;
(c) a step for classifying one or more difference items included in the difference information into a plurality of categories;
(d) a step for extracting, among the difference items, a specific difference item that belongs in a specific category of the plurality of categories; and
(e) a step for notifying about the specific category of the specific difference item.

2. The method according to claim 1, wherein
the steps (a) through (e) are executed by triggering a backup process of the first backup file.

3. The method according to claim 1, wherein
the step (e) includes a step for informing a preset contact point of the specific category of the specific difference item.

4. The method according to claim 1, further comprising:
a step for creating a backup file history list that includes the second backup file and the first backup file, assigning the specific category of the specific difference item on the backup file history list, and displaying it.

5. The method according to claim 1, wherein
the first backup file includes data that has a difference from the second backup file, without including data that has no difference from the second backup file.

6. The method according to claim 1, further comprising:
a step for exporting a list of one or more backup files, each of which includes the specific category of the specific difference item.

7. The method according to claim 1, wherein
the step (e) includes a step for notifying about content of the specific difference item together with the specific category.

8. The method according to claim 7, wherein
the project file includes a plurality of data files and
the content of the specific difference item includes a data file name in which the specific difference item exists.

9. A robot management device for managing a project file of a robot, comprising:
a storage section that stores a backup file of the project file and
a difference processing section configured to perform difference processing using the backup file, wherein
the difference processing includes
(a) a process of acquiring a specific first backup file and a second backup file that was backed up before the first backup file,
(b) a process of creating difference information by detecting a difference from the second backup file to the first backup file,
(c) a process of classifying one or more difference items included in the difference information into a plurality of categories,
(d) a process of extracting, among the difference items, a specific difference item that belongs in a specific category of the plurality of categories, and
(e) a process of notifying about the specific category of the specific difference item.

10. A robot system comprising:
one or more robots and
a robot management device that manages a project file of the robot, wherein
the robot management device includes
a storage section that stores a backup file of the project file and
a difference processing section configured to perform difference processing using the backup file, and
the difference processing includes
(a) a process of acquiring a specific first backup file and a second backup file that was backed up before the first backup file,
(b) a process of creating difference information by detecting a difference from the second backup file to the first backup file,
(c) a process of classifying one or more difference items included in the difference information into a plurality of categories,
(d) a process of extracting, among the difference items, a specific difference item that belongs in a specific category of the plurality of categories, and
(e) a process of notifying about the specific category of the specific difference item.
